(19) United States
(12) Patent Application Publication
(10) Pub. No.: US 2025/0159619 A1
(43) Pub. Date: May 15, 2025

(54) SS/PBCH BLOCK PATTERNS

(71) Applicant: Samsung Electronics Co., Ltd., Suwon-si (KR)

(72) Inventors: Hongbo Si, Allen, TX (US); Eko Onggosanusi, Coppell, TX (US)

(21) Appl. No.: 18/926,195

(22) Filed: Oct. 24, 2024

Related U.S. Application Data
(60) Provisional application No. 63/547,932, filed on Nov. 9, 2023.

(51) Int. Cl. H04W 56/00; H04W 48/10; H04W 72/044

(52) U.S. Cl. CPC H04W 56/001; H04W 48/10; H04W 72/044

(57) ABSTRACT

Methods and apparatuses for synchronization signal/physical broadcast channel (SS/PBCH) block pattern. A method of a user equipment (UE) in a wireless communication system includes determining a pattern for SS/PBCH blocks including N candidate SS/PBCH blocks in a time domain and M candidate SS/PBCH blocks in a frequency domain and identifying, for a SS/PBCH block, a first index īₜ(0≤īₜ≤N−1) from the N candidate SS/PBCH blocks in the time domain and a second index ī_{f}(0≤ī_{f}≤M−1) from M candidate SS/PBCH blocks in the frequency domain. The method further includes receiving, from a base station (BS), the SS/PBCH block based on the pattern.

### CROSS-REFERENCE TO RELATED AND CLAIM OF PRIORITY

The present application claims priority under 35 U.S.C. § 119(e) to U.S. Provisional Patent Application No. 63/547,932 filed on Nov. 9, 2023, which is hereby incorporated by reference in its entirety.

### TECHNICAL FIELD

The present disclosure relates generally to wireless communication systems and, more specifically, the present disclosure relates to methods and apparatuses for synchronization signal/physical broadcast channel (SS/PBCH) block patterns.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to SS/PBCH block patterns.

In one embodiment, a user equipment (UE) in a wireless communication system is provided. The UE includes a processor configured to determine a pattern for synchronization signals and physical broadcast channel (SS/PBCH) blocks including N candidate SS/PBCH blocks in a time domain and M candidate SS/PBCH blocks in a frequency domain and identify, for a SS/PBCH block, (i) a first index īₜ(0≤īₜ≤N−1) from the N candidate SS/PBCH blocks in the time domain and (ii) a second index ī_{f}(0≤ī_{f}≤M−1) from M candidate SS/PBCH blocks in the frequency domain. The UE further includes a transceiver operably coupled to the processor. The transceiver is configured to receive, from a base station (BS), the SS/PBCH block based on the pattern.

In another embodiment, a BS in a wireless communication system is provided. The BS includes a processor configured to determine a pattern for SS/PBCH blocks including N candidate SS/PBCH blocks in a time domain and M candidate SS/PBCH blocks in a frequency domain and determine, for a SS/PBCH block, (i) a first index īₜ(0≤īₜ≤N−1) from the N candidate SS/PBCH blocks in the time domain and (ii) a second index ī_{f}(0≤ī_{f}≤M−1) from M candidate SS/PBCH blocks in the frequency domain. The BS further includes a transceiver operably coupled to the processor. The transceiver is configured to transmit, to a UE, the SS/PBCH block based on the pattern.

In yet another embodiment, a method of a UE in a wireless communication system is provided. The method includes determining a pattern for SS/PBCH blocks including N candidate SS/PBCH blocks in a time domain and M candidate SS/PBCH blocks in a frequency domain and identifying, for a SS/PBCH block, (i) a first index īₜ(0≤īₜ≤N−1) from the N candidate SS/PBCH blocks in the time domain and (ii) a second index ī_{f}(0≤ī_{f}≤M−1) from M candidate SS/PBCH blocks in the frequency domain. The method further includes receiving, from a BS, the SS/PBCH block based on the pattern.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrates an example of a wireless transmit and receive paths according to embodiments of the present disclosure;

FIG. 5 illustrates an example architecture for a SS/PBCH block according to embodiments of the present disclosure;

FIG. 6 illustrates diagrams of example SS/PBCH block time domain patterns according to embodiments of the present disclosure;

FIG. 7 illustrates a diagram of example time domain slots containing candidate SS/PBCH blocks according to embodiments of the present disclosure;

FIG. 8 illustrates an example of a timeline for SS/PBCH block patterns in frequency domain and time domain according to embodiments of the present disclosure; and

FIG. 9 illustrates a flowchart of an example UE procedure for receiving SS/PBCH blocks according to embodiments of the present disclosure.

### DETAILED DESCRIPTION

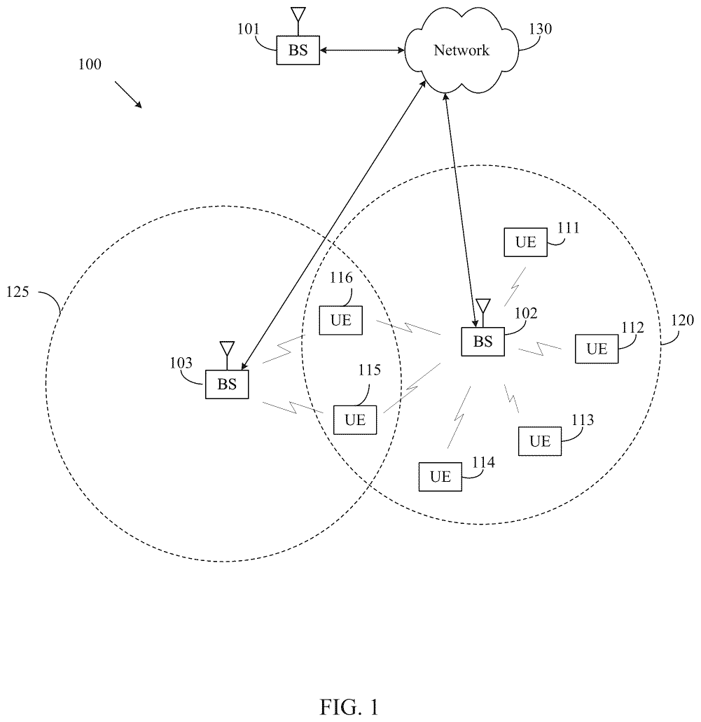

FIGS. 1-9, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [1] 3GPP TS 38.211 v18.3.0, “NR; Physical channels and modulation;” [2] 3GPP TS 38.212 v18.3.0, “NR; Multiplexing and Channel coding;” [3]3GPP TS 38.213 v18.3.0, “NR; Physical Layer Procedures for Control;” [4] 3GPP TS 38.214 v18.3.0, “NR; Physical Layer Procedures for Data;” [5] 3GPP TS 38.321 v18.2.0, “NR; Medium Access Control (MAC) protocol specification;” and [6] 3GPP TS 38.331 v18.2.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for identifying and/or receiving SS/PBCH block patterns. In certain embodiments, one or more of the BSs 101-103 include circuitry, programing, or a combination thereof to support or transmit SS/PBCH blocks according to a pattern.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

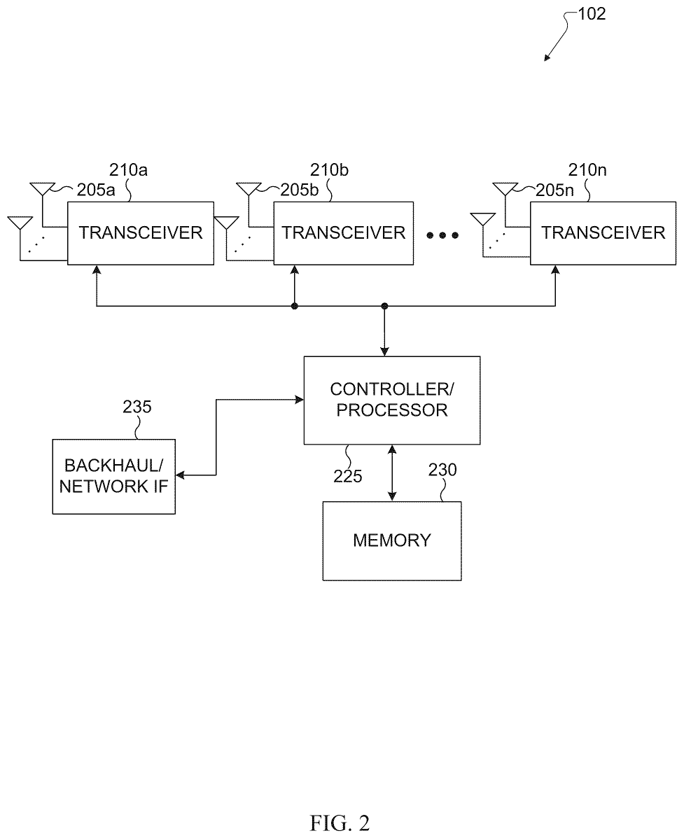

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as supporting or transmitting SS/PBCH blocks according to patterns. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

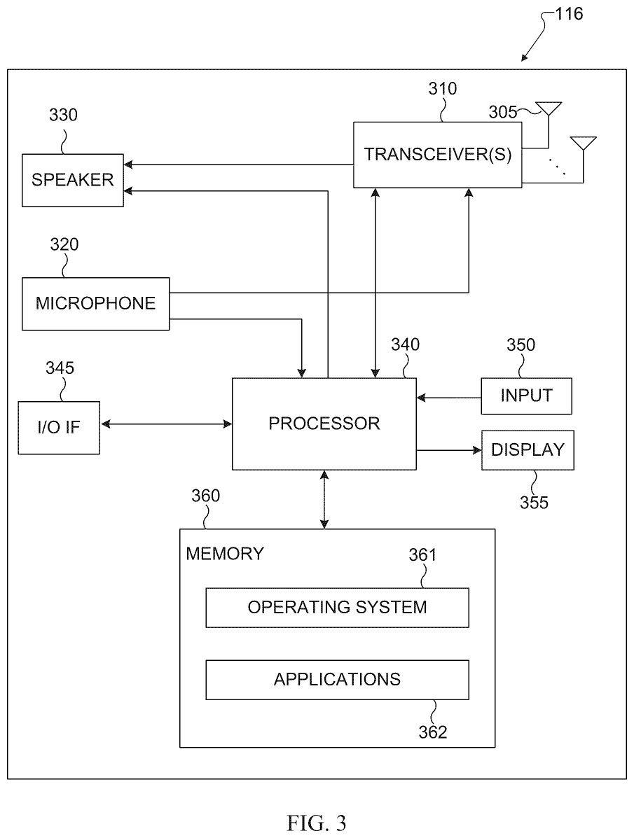

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to receive SS/PBCH block according to patterns as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

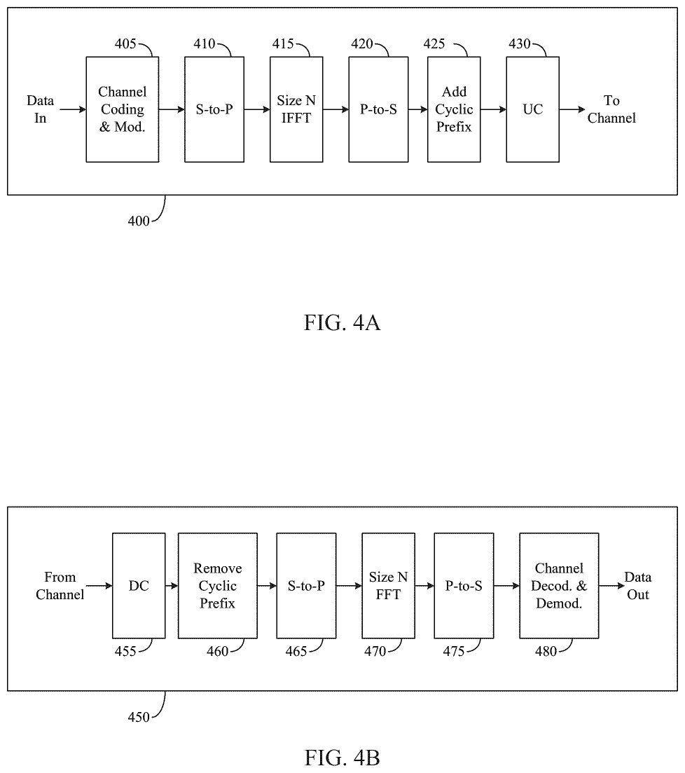

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 is configured to utilize SS/PBCH block patterns as described in embodiments of the present disclosure.

As illustrated in FIG. 4A, the transmit path 400 includes a channel coding and modulation block 205, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Any of the above variation embodiments can be utilized independently or in combination with at least one other variation embodiment.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of subject matter is defined by the claims.

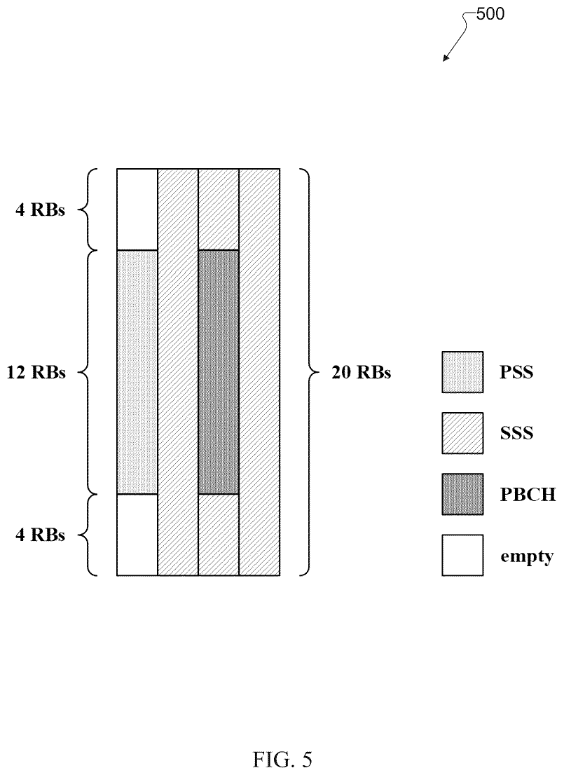

FIG. 5 illustrates an example architecture for a SS/PBCH block 500 according to embodiments of the present disclosure. For example, SS/PBCH block 500 can be received by any of the UEs 111-116 of FIG. 1, such as the UE 111. This example is for illustration only and other embodiments can be used without departing from the scope of the present disclosure.

In NR Rel-15, each synchronization signals and physical broadcast channel (SS/PBCH) block compromises of four consecutive orthogonal frequency division multiplexing (OFDM) symbols, wherein the center 12 resource blocks (RBs) of the first symbol are mapped for primary synchronization signal (PSS), the second and forth symbols ae mapped for PBCH, and the third symbol is mapped for both secondary synchronization signal (SSS) and PBCH. With reference to FIG. 5, an illustration of the SS/PBCH block composition is shown. The same SS/PBCH composition is applied to supported carrier frequency ranges in NR, which spans from 0.41 GHz to 7.125 GHz as Frequency Range 1 (FR1), and spans from 24.25 to 52.6 GHz as Frequency Range 2 (FR2). In every RB mapped for PBCH, 3 out of the 12 resource elements (REs) are mapped for the demodulation reference signal (DM-RS) of PBCH, wherein the 3 REs are uniformly distributed in the RB and the starting location of the first RE is based on cell identity (ID).

NR Rel-15 supports one or two subcarrier spacing (SCS) for SS/PBCH block, for a given band, wherein the same SCS is applied to PSS, SSS, and PBCH (including its DM-RS). For FR1, 15 kHz and/or 30 kHz can be applied to SS/PBCH block, and for FR2, 120 kHz and/or 240 kHz can be applied to SS/PBCH block.

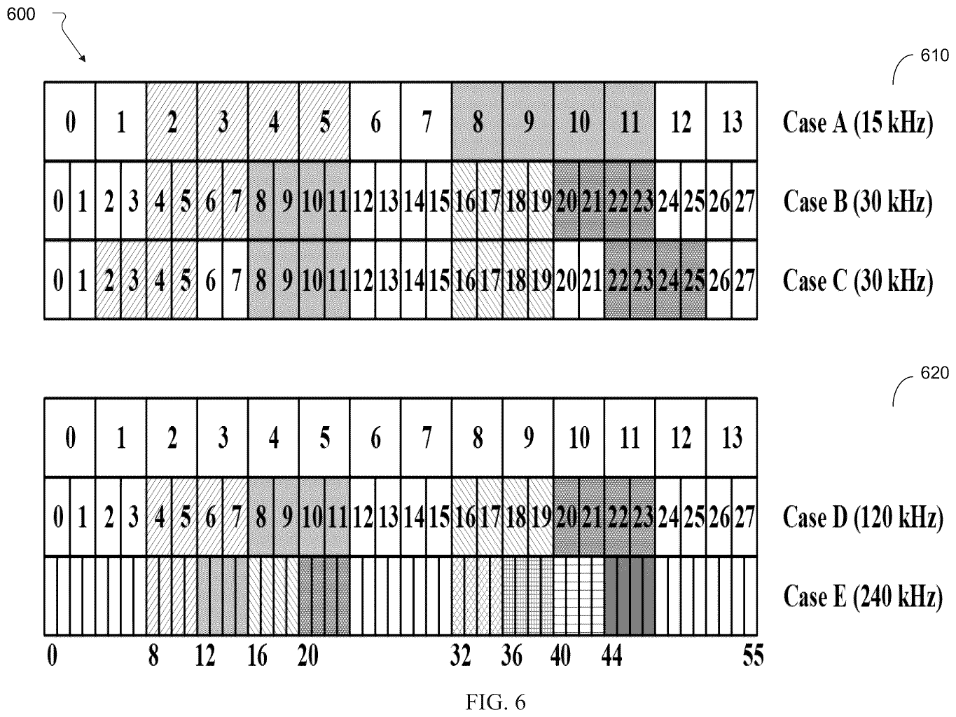

FIG. 6 illustrates diagrams of example SS/PBCH block time domain patterns 600 according to embodiments of the present disclosure. For example, SS/PBCH block time domain patterns 600 can be utilized by any of the UEs 111-116 of FIG. 1, such as the UE 112. This example is for illustration only and other embodiments can be used without departing from the scope of the present disclosure.

NR Rel-15 also supports multiple candidate SS/PBCH blocks within a time unit of half frame, wherein the time unit repeats in time domain with a configurable periodicity. With reference to FIG. 6, the time domain pattern of SS/PBCH blocks to at least one slot is shown. For FR1 (610), the SS/PBCH block pattern is designed according to 15 kHz as the reference SCS, and for FR2 (620), the SS/PBCH block pattern is designed according to 60 kHz as the reference SCS.

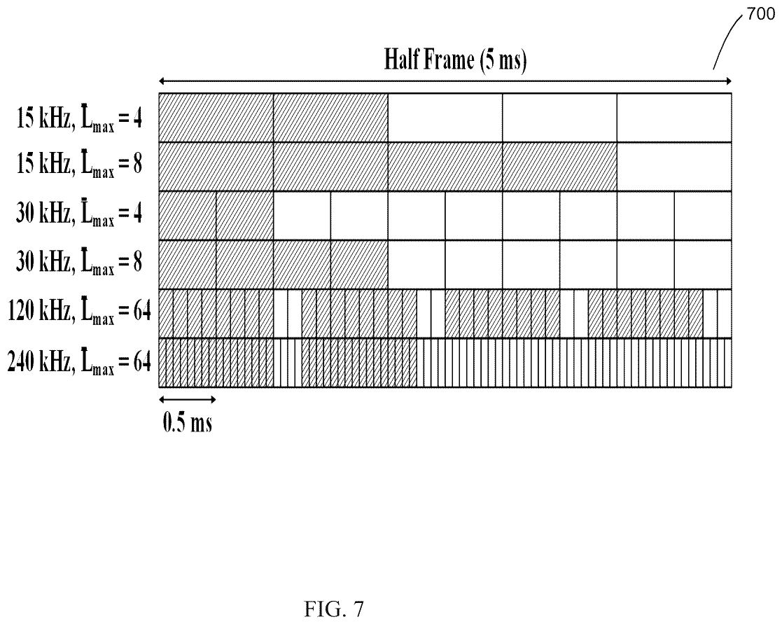

FIG. 7 illustrates a diagram of example time domain slots containing candidate SS/PBCH blocks 700 according to embodiments of the present disclosure. For example, time domain slots containing candidate SS/PBCH blocks 700 can be monitored by any of the UEs 111-116 of FIG. 1, such as the UE 113. This example is for illustration only and other embodiments can be used without departing from the scope of the present disclosure.

The maximum number of candidate SS/PBCH blocks, denoted as L̅ₘₐₓ, is determined based on carrier frequency range, and for FR1 and FR2 licensed spectrums, the value can be one of 4 or 8 or 64, for a given carrier frequency range. With reference to FIG. 7, an illustration of the time domain pattern for the slots containing candidate SS/PBCH blocks within a half frame is shown.

Embodiments of the present disclosure recognize that for new generation of wireless communication, a base station can generate more than one SS/PBCH block in the frequency domain at a single time instance, such that the SS/PBCH block pattern can include both frequency domain pattern and time domain pattern. This disclosure includes aspects for SS/PBCH block pattern in both frequency domain and time domain.

This disclosure focuses on the SS/PBCH block pattern in both time domain and frequency domain. More precisely, the following aspects are included in the present disclosure:
SS/PBHC block pattern with both time domain and frequency domain pattern
SS/PBCH block index
Quasi co-location (QCL) assumption for SS/PBCH block
Actually transmitted SS/PBCH block

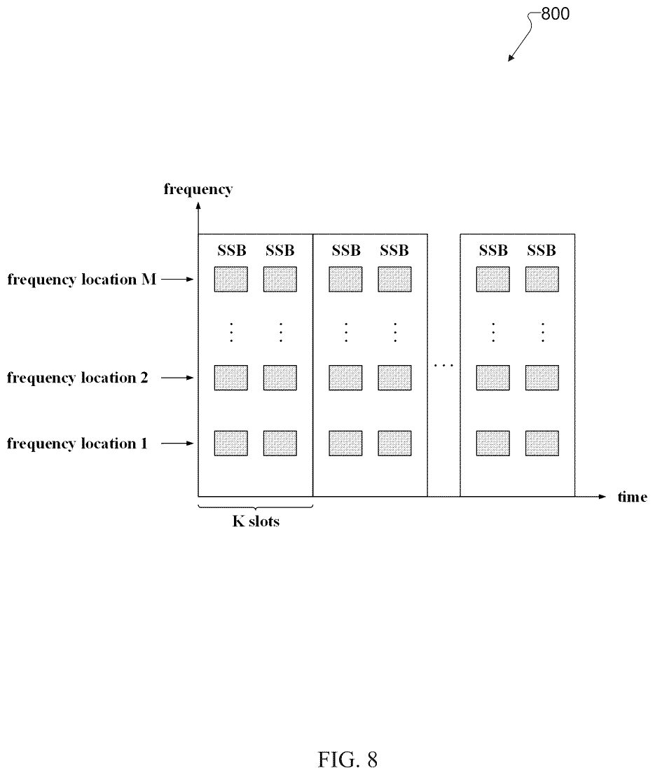

FIG. 8 illustrates an example of a timeline 800 for SS/PBCH block patterns in frequency domain and time domain according to embodiments of the present disclosure. For example, timeline 800 for SS/PBCH block patterns in frequency domain and time domain can be followed by any of the UEs 111-116 of FIG. 1, such as the UE 114. This example is for illustration only and other embodiments can be used without departing from the scope of the present disclosure.

In one embodiment, a SS/PBCH block pattern can include a time domain pattern (e.g., periodically showing up in the time domain) and a frequency domain pattern (e.g., repetition(s) of the time domain pattern in the frequency domain).

In one example, the time domain pattern can be expressed in the way that the first symbols of the candidate SS/PBCH blocks within a predefined time period have indexes of Sₛₜₐᵣₜ+N_{symb}^{slot}·K·n, wherein K is the size of a predefined time unit in term of slots, N_{symb}^{slot} is the number of symbols in a slot (e.g., 14 for normal CP and 12 for extended CP), and Sₛₜₐᵣₜ is the set of symbols as the first symbols of the candidate SS/PBCH blocks within the predefined time unit. n is an index of the predefined time unit within the predefined time period, wherein n∈S_{index}.

For one sub-example, the value of Sₛₜₐᵣₜ and/or K can be predetermined in the specification. For one instance, Sₛₜₐᵣₜ and/or K can be predetermined according to a SCS of the SS/PBCH block and/or a frequency range or band where the SS/PBCH block is transmitted. For another instance, this sub-example can be applicable for initial cell search procedure.

For another sub-example, the value of Sₛₜₐᵣₜ can be configured by a higher layer parameter. For one instance, the higher layer parameter can be system information (e.g., SIB1, or SIBx where x>1). For another instance, the higher layer parameter can be dedicated RRC parameters for providing common parameters of a serving cell (e.g., a secondary serving cell). For yet another instance, this sub-example can be applicable after initial cell search procedure.

For yet another sub-example, the value of K can be configured by a higher layer parameter. For one instance, the higher layer parameter can be system information (e.g., SIB1, or SIBx where x>1). For another instance, the higher layer parameter can be dedicated RRC parameters for providing common parameters of a serving cell (e.g., a secondary serving cell). For yet another instance, this sub-example can be applicable after initial cell search procedure.

For yet another sub-example, the maximum number of candidate SS/PBCH blocks in the time domain with the predefined time period can be determined as |Sₛₜₐᵣₜ|·|S_{index}|. For one instance, the maximum number of candidate SS/PBCH blocks can be determined per SCS of the SS/PBCH block and/or a frequency range or band where the SS/PBCH block is transmitted.

In another example, the frequency domain pattern can be expressed in the way that the centers of the candidate SS/PBCH blocks (e.g., the center subcarrier of the SS/PBCH block) on different frequency layers are aligned with a set of frequency locations, e.g., denoted as frequency locations 1, 2, . . . , M, as in FIG. 8.

For one sub-example, the frequency domain pattern includes frequency locations of the candidate SS/PBCH blocks with the same interval between two consecutive frequency locations, such that the frequency domain pattern can be expressed as fₛₜₐᵣₜ+(m−1)·fᵢₙₜₑᵣᵥₐₗ, where fₛₜₐᵣₜ is the frequency location of the lowest SS/PBCH block (e.g., frequency location 1 in FIG. 8), m is the index of the frequency locations with 1≤m≤M, and fᵢₙₜₑᵣᵥₐₗ is a same interval between two consecutive frequency locations (e.g., applicable when M>1).
For one instance, fₛₜₐᵣₜ can be according to a synchronization raster entry value. For one further consideration, the set of frequency domain locations fₛₜₐᵣₜ+(m−1)·fᵢₙₜₑᵣᵥₐₗ (1≤m≤M) are all according to a set of synchronization raster entry values (e.g., a cluster of synchronization raster entry values). For another further consideration, this instance can be applicable for initial cell search procedure.
For another instance, fₛₜₐᵣₜ can be provided by a higher layer parameter. For one sub-instance, the higher layer parameter can be system information (e.g., SIB1, or SIBx where x>1). For another sub-instance, the higher layer parameter can be dedicated RRC parameters for providing common parameters of a serving cell (e.g., a secondary serving cell). For yet another sub-instance, this instance can be applicable after initial cell search procedure.
For yet another instance, fᵢₙₜₑᵣᵥₐₗ can be fixed or predetermined in the specification. For one sub-instance, fᵢₙₜₑᵣᵥₐₗ can be same as the SS/PBCH block bandwidth such that there is no gap between the two consecutive candidate SS/PBCH blocks in the frequency domain. For another sub-instance, fᵢₙₜₑᵣᵥₐₗ can be same as or an integer multiple of the interval between two consecutive synchronization raster entries. For yet another sub-instance, this instance can be applicable for initial cell search procedure.
For yet another instance, fᵢₙₜₑᵣᵥₐₗ can be provided by a higher layer parameter. For one sub-instance, the higher layer parameter can be system information (e.g., SIB1, or SIBx where x>1). For another sub-instance, the higher layer parameter can be dedicated RRC parameters for providing common parameters of a serving cell (e.g., a secondary serving cell). For one further consideration, fᵢₙₜₑᵣᵥₐₗ is not expected to be configured smaller than the SS/PBCH block bandwidth. For yet another sub-instance, this instance can be applicable after initial cell search procedure.

For yet another instance, fᵢₙₜₑᵣᵥₐₗ can include two parts: a first part same as the bandwidth of the SS/PBCH block, and a second part as a gap between two consecutive candidate SS/PBCH blocks in the frequency domain. The first part can be fixed in the specification or provided by a higher layer parameter, and/or the second part can be either fixed in the specification or provided by a higher layer parameter. For one sub-instance, the higher layer parameter can be system information (e.g., SIB1, or SIBx where x>1). For another sub-instance, the higher layer parameter can be dedicated RRC parameters for providing common parameters of a serving cell (e.g., a secondary serving cell). For yet another sub-instance, when fᵢₙₜₑᵣᵥₐₗ is fixed (e.g., both first and second parts are fixed) in the specification, it can be applicable for initial cell search procedure. For yet another sub-instance, when fᵢₙₜₑᵣᵥₐₗ is configurable (e.g., either first or second part is configured), it can be applicable after initial cell search procedure. For another sub-example, the frequency domain pattern includes frequency locations of the candidate SS/PBCH blocks with the same interval between two consecutive frequency locations, such that the frequency domain pattern can be expressed as fₛₜₐᵣₜ−(m−1)·fᵢₙₜₑᵣᵥₐₗ, where fₛₜₐᵣₜ is the frequency location of the highest SS/PBCH block (e.g., frequency location M in FIG. 8), m is the index of the frequency locations with 1≤m≤M, and fᵢₙₜₑᵣᵥₐₗ is a same interval between two consecutive frequency locations (e.g., applicable when M>1).
For one instance, fₛₜₐᵣₜ can be according to a synchronization raster entry value. For one further consideration, the set of frequency domain locations fₛₜₐᵣₜ−(m−1)·fᵢₙₜₑᵣᵥₐₗ (1≤m≤M) are all according to a set of synchronization raster entry values (e.g., a cluster of synchronization raster entry values). For another further consideration, this instance can be applicable for initial cell search procedure.
For another instance, fₛₜₐᵣₜ can be provided by a higher layer parameter. For one sub-instance, the higher layer parameter can be system information (e.g., SIB1, or SIBx where x>1). For another sub-instance, the higher layer parameter can be dedicated RRC parameters for providing common parameters of a serving cell (e.g., a secondary serving cell).
For yet another instance, fᵢₙₜₑᵣᵥₐₗ can be fixed or predetermined in the specification. For one sub-instance, fᵢₙₜₑᵣᵥₐₗ can be same as the SS/PBCH block bandwidth such that there is no gap between the two consecutive candidate SS/PBCH blocks in the frequency domain. For another sub-instance, fᵢₙₜₑᵣᵥₐₗ can be same as or an integer multiple of the interval between two consecutive synchronization raster entries. For yet another sub-instance, this instance can be applicable for initial cell search procedure.
For yet another instance, fᵢₙₜₑᵣᵥₐₗ can be provided by a higher layer parameter. For one sub-instance, the higher layer parameter can be system information (e.g., SIB1, or SIBx where x>1). For another sub-instance, the higher layer parameter can be dedicated RRC parameters for providing common parameters of a serving cell (e.g., a secondary serving cell). For one further consideration, fᵢₙₜₑᵣᵥₐₗ is not expected to be configured smaller than the SS/PBCH block bandwidth.

For yet another instance, fᵢₙₜₑᵣᵥₐₗ can include two parts: a first part same as the bandwidth of the SS/PBCH block, and a second part as a gap between two consecutive candidate SS/PBCH blocks in the frequency domain. The first part can be fixed in the specification or provided by a higher layer parameter, and/or the second part can be either fixed in the specification or provided by a higher layer parameter. For one sub-instance, the higher layer parameter can be system information (e.g., SIB1, or SIBx where x>1). For another sub-instance, the higher layer parameter can be dedicated RRC parameters for providing common parameters of a serving cell (e.g., a secondary serving cell). For yet another sub-instance, when fᵢₙₜₑᵣᵥₐₗ is fixed (e.g., both first and second parts are fixed) in the specification, it can be applicable for initial cell search procedure. For yet another sub-instance, when fᵢₙₜₑᵣᵥₐₗ is configurable (e.g., either first or second part is configured), it can be applicable after initial cell search procedure. For yet another sub-example, the frequency locations in the frequency domain pattern can be provided by higher layer parameters, e.g., a list of parameters indicating the frequency locations. For one instance, the higher layer parameters can be system information (e.g., SIB1, or SIBx where x>1). For another instance, the higher layer parameters can be dedicated RRC parameters for providing common parameters of a serving cell (e.g., a secondary serving cell). For yet another instance, the interval between any two consecutive candidate SS/PBCH blocks in the frequency domain may not expect to be configured smaller than the SS/PBCH block bandwidth. For yet another instance, this sub-example can be applicable after initial cell search procedure.

For yet another sub-example, M is the number of frequency locations for the candidate SS/PBCH blocks, and it can be predetermined in the specification. For one instance, M can be predetermined according to a SCS of the SS/PBCH block and/or a frequency range or band where the SS/PBCH block is transmitted. For another instance, this sub-example can be applicable for initial cell search procedure.

For yet another sub-example, M is the number of frequency locations for the candidate SS/PBCH blocks, and it can be provided by higher layer parameters. For one instance, the higher layer parameters can be system information (e.g., SIB1, or SIBx where x>1). For another instance, the higher layer parameters can be dedicated RRC parameters for providing common parameters of a serving cell (e.g., a secondary serving cell). For yet another instance, this sub-example can be applicable after initial cell search procedure.

In one embodiment, candidate SS/PBCH blocks in a SS/PBCH block pattern can have at least one associated candidate SS/PBCH block index.

For one example, the candidate SS/PBCH blocks in the SS/PBCH block pattern can be indexed in the order of the frequency domain first, and in the order of the time domain second, such that the index ī associated with the candidate SS/PBCH block is with 0≤ī≤N·M−1, where N is the maximum number of candidate SS/PBCH blocks in the time domain within the predefined time period, and M is the number of frequency locations for the candidate SS/PBCH blocks. For the candidate SS/PBCH block located at the īₜ-th in the time domain, and the ī_{f}-th in the frequency domain, wherein 0≤īₜ≤N−1 and 0≤ī_{f}≤M−1, its candidate SS/PBCH block index can be given by ī=īₜ·M+ī_{f}, and the corresponding candidate SS/PBCH block index in time domain is given by īₜ, and the corresponding candidate SS/PBCH block index in frequency domain is given by ī_{f}.

For another example, the candidate SS/PBCH blocks in the SS/PBCH block pattern can be indexed in the order of the time domain first, and in the order of the frequency domain second, such that the index ī associated with the candidate SS/PBCH block is with 0≤ī≤N·M−1, where N is the maximum number of candidate SS/PBCH blocks in the time domain within the predefined time period, and M is the number of frequency locations for the candidate SS/PBCH blocks. For the candidate SS/PBCH block located at the īₜ-th in the time domain, and the ī_{f}-th in the frequency domain, wherein 0īₜ≤N−1 and 0≤ī_{f}≤M−1, its candidate SS/PBCH block index can be given by ī=ī_{f}·N+īₜ, and the corresponding candidate SS/PBCH block index in time domain is given by īₜ, and the corresponding candidate SS/PBCH block index in frequency domain is given by ī_{f}.

For yet another example, the candidate SS/PBCH blocks in the SS/PBCH block pattern can be indexed by two indexes: a first index for the time domain, and a second index for the frequency domain. For the candidate SS/PBCH block located at the īₜ-th in the time domain, and the ī_{f}-th in the frequency domain, wherein 0≤īₜ≤N−1 and 0≤ī_{f}≤M−1, its associated candidate SS/PBCH block index (or index pair) can be given by (īₜ, ī_{f}) or (ī_{f}, īₜ), where N is the maximum number of candidate SS/PBCH blocks in the time domain within the predefined time period, and M is the number of frequency locations for the candidate SS/PBCH blocks. The corresponding candidate SS/PBCH block index in time domain is given by īₜ, and the corresponding candidate SS/PBCH block index in frequency domain is given by ī_{f}.

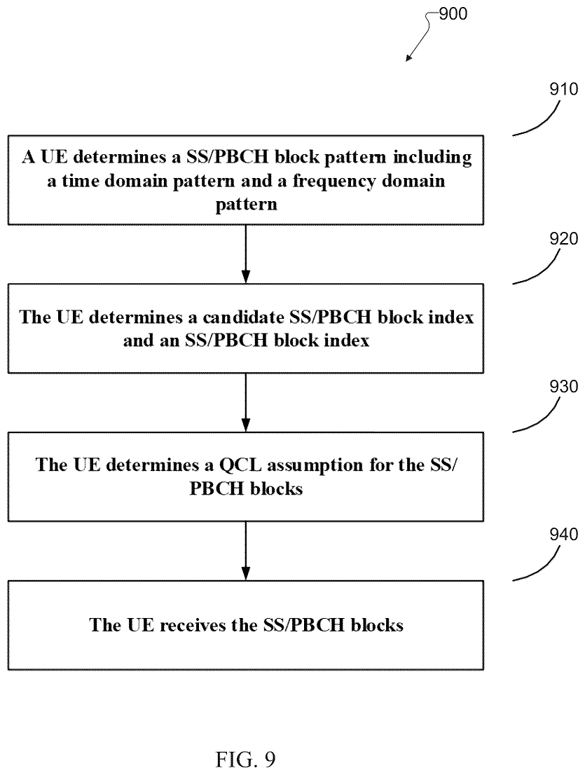

FIG. 9 illustrates a flowchart of an example UE procedure 900 for receiving SS/PBCH blocks according to embodiments of the present disclosure. For example, procedure 900 for receiving SS/PBCH blocks can be followed by any of the UEs 111-116 of FIG. 1, such as the UE 116. This example is for illustration only and other embodiments can be used without departing from the scope of the present disclosure.

The procedure begins in 910, a UE determines a SS/PBCH block pattern including a time domain pattern and a frequency domain pattern. In 920, the UE determines a candidate SS/PBCH block index and an SS/PBCH block index. In 930, the UE determines a QCL assumption for the SS/PBCH blocks. In 940, the UE receives the SS/PBCH block(s).

In one embodiment, candidate SS/PBCH blocks can be expected to be QCLed based on the SS/PBCH block indexes, wherein the SS/PBCH block index of an SS/PBCH block can be determined based on the candidate SS/PBCH block index.

For one example, the SS/PBCH block index (e.g., i) can be same as the candidate SS/PBCH block index (e.g., ī), e.g., i=T. For one instance, this can be applicable for operation without shared spectrum channel access. For another instance, this can be applicable when a QCL parameter for the SS/PBCH blocks is not applicable (e.g., not provided).

For another example, the SS/PBCH block index in time domain (e.g., iₜ) can be same as the candidate SS/PBCH block index in time domain (e.g., īₜ), e.g., iₜ=īₜ. For one instance, this can be applicable for operation without shared spectrum channel access. For another instance, this can be applicable when a QCL parameter for the SS/PBCH blocks in the time domain is not applicable (e.g., not provided).

For yet another example, the SS/PBCH block index in frequency domain (e.g., i_{f}) can be same as the candidate SS/PBCH block index in frequency domain (e.g., ī_{f}), e.g., i_{f}=ī_{f}. For one instance, this can be applicable for operation without shared spectrum channel access. For another instance, this can be applicable when a QCL parameter for the SS/PBCH blocks in the frequency domain is not applicable (e.g., not provided).

For one example, the SS/PBCH block index (e.g., i) can be derived based on the candidate SS/PBCH block index (e.g., ī). For instance, this can be applicable for operation with shared spectrum channel access. For another instance, this can be applicable when a QCL parameter for the SS/PBCH blocks is provided. For yet another instance, i=ī mod Q, wherein Q is the QCL parameter for the SS/PBCH blocks.

For another example, the SS/PBCH block index in time domain (e.g., iₜ) can be derived based on the candidate SS/PBCH block index in time domain (e.g., īₜ). For instance, this can be applicable for operation with shared spectrum channel access. For another instance, this can be applicable when a QCL parameter for the SS/PBCH blocks in the time domain is provided. For yet another instance, iₜ=īₜ mod Qₜ, wherein Qₜ is the QCL parameter for the SS/PBCH blocks in the time domain.

For yet another example, the SS/PBCH block index in frequency domain (e.g., i_{f}) can be derived based on the candidate SS/PBCH block index in frequency domain (e.g., ī_{f}). For instance, this can be applicable for operation with shared spectrum channel access. For another instance, this can be applicable when a QCL parameter for the SS/PBCH blocks in the frequency domain is provided. For yet another instance, i_{f}=ī_{f} mod Q_{f}, wherein Q_{f} is the QCL parameter for the SS/PBCH blocks in the frequency domain.

For one example, the UE (e.g., the UE 116) can expect SS/PBCH blocks with the same SS/PBCH block index in the time domain are QCLed. For one instance, the SS/PBCH blocks can be in a same predefined time periods or across different predefined time periods. For another instance, the SS/PBCH blocks can be in a same transmission window or across different transmission windows.

For another example, the UE can expect SS/PBCH blocks on different frequency locations and with the same SS/PBCH block index in the frequency domain are QCLed.

For yet another example, the UE can expect SS/PBCH blocks with the same SS/PBCH block index are QCLed. For one instance, the SS/PBCH blocks can be in a same predefined time periods or across different predefined time periods. For another instance, the SS/PBCH blocks can be in a same transmission window or across different transmission windows.

For yet another example, the UE can expect SS/PBCH blocks with the same SS/PBCH block index in time domain and the same SS/PBCH block index in the frequency domain are QCLed. For one instance, the SS/PBCH blocks can be in a same predefined time periods or across different predefined time periods. For another instance, the SS/PBCH blocks can be in a same transmission window or across different transmission windows.

In one embodiment, a UE can be provided with an indication on the actually transmitted SS/PBCH blocks.

For one example, the indication can be with a bitmap of a length of N·M, where N is the maximum number of candidate SS/PBCH blocks in the time domain with the predefined time period, and M is the number of frequency locations for the candidate SS/PBCH blocks, and each bit in the bitmap corresponds to a candidate SS/PBCH block in the SS/PBCH block pattern. The bit taking value of 1 can indicate the corresponding candidate SS/PBCH block is transmitted. The bit taking value of 0 can indicate the corresponding candidate SS/PBCH block is not transmitted.

For another example, the indication can be with a bitmap of a length of Nₜ·M_{f}, where Nₜ−1 is the maximum value of it (e.g., 0≤iₜ≤Nₜ−1), and M_{f}−1 is the maximum value of i_{f} (e.g., 0≤i_{f}≤M_{f}−1), and each bit in the bitmap corresponds to a combination of iₜ and i_{f}. The bit taking value of 1 can indicate the candidate SS/PBCH block corresponding to the combination of iₜ and i_{f} may be transmitted. The bit taking value of 0 can indicate the candidate SS/PBCH block corresponding to the combination of iₜ and i_{f} is not transmitted.

For yet another example, the indication can be with two bitmaps: a first bitmap with a length of N, where N is the maximum number of candidate SS/PBCH blocks in the time domain with the predefined time period, and each bit in the bitmap corresponds to a candidate SS/PBCH block in the time domain; and a second bitmap with a length of M, where M is the number of frequency locations for the candidate SS/PBCH blocks in the frequency domain, and each bit in the bitmap corresponds to a candidate SS/PBCH block in the frequency domain. The combination of bits from the two bitmaps both taking value of 1 can indicate the candidate SS/PBCH block with the corresponding SS/PBCH block index in the time and frequency domain is transmitted; and if any of the two bits in the combination takes a value of 0, the candidate SS/PBCH block with the corresponding SS/PBCH block index in the time and frequency domain is not transmitted. For one further consideration, the second bitmap can be absent, which implies the transmission status (e.g., transmitted or not transmitted) for the SS/PBCH blocks with the same time domain index is same.

For yet another example, the indication can be with two bitmaps: a first bitmap with a length of Nₜ, where Nₜ−1 is the maximum value of iₜ, and each bit in the bitmap corresponds to a value of iₜ; and a second bitmap with a length of M_{f}, where M_{f}−1 is the maximum value of i_{f}, and each bit in the bitmap corresponds to a value of i_{f}. The combination of bits from the two bitmaps both taking value of 1 can indicate the candidate SS/PBCH block corresponding to the combination of iₜ and i_{f} may be transmitted; and i_{f} any of the two bits in the combination takes a value of 0, the candidate SS/PBCH block corresponding to the combination of iₜ and i_{f} is not transmitted. For one further consideration, the second bitmap can be absent, which implies the transmission status (e.g., transmitted or not transmitted) for the SS/PBCH blocks with the same time domain index iₜ is same.

For one example, the indication can be provided by higher layer parameters. For one instance, the higher layer parameters can be system information (e.g., SIB1, or SIBx where x>1). For another instance, the higher layer parameters can be dedicated RRC parameters for providing common parameters of a serving cell (e.g., a secondary serving cell). For yet another instance, if both system information and dedicated RRC parameters provided the indication, the indication provided by system information can be overridden by the indication provided by the dedicated RRC parameters. For yet another instance, if both system information and dedicated RRC parameters provided the indication, the UE (e.g., the UE 116) expects the actually transmitted SS/PBCH blocks indicated by the indication provided by the dedicated RRC parameters is a subset (including the same set) of the actually transmitted SS/PBCH blocks indicated by the indication provided system information.

For example, in 910, the pattern may include N candidate SS/PBCH blocks in a time domain and M candidate SS/PBCH blocks in a frequency domain. In various embodiments, the UE determines a first bitmap indicating actually transmitted SS/PBCH blocks in the time domain and determines a second bitmap indicating actually transmitted SS/PBCH blocks in the frequency domain.

For example, in 920, the UE may identify, for a SS/PBCH block, a first index īₜ(0≤īₜ≤N−1) from the N candidate SS/PBCH blocks in the time domain and a second index ī_{f}(0≤ī_{f}≤M−1) from M candidate SS/PBCH blocks in the frequency domain.

In various embodiments, first symbols for the N candidate SS/PBCH blocks in the time domain are given by Sₛₜₐᵣₜ+N_{symb}^{slot}·K·n, where K is a number of slots for a predefined time unit, N_{symb}^{slot} is a number of symbols in a slot, Sₛₜₐᵣₜ is a set of symbols as first symbols of candidate SS/PBCH blocks within the predefined time unit, and n is an index of the predefined time unit.

In various embodiments, frequency locations for the M candidate SS/PBCH blocks in the frequency domain are given by fₛₜₐᵣₜ+(m−1)·fᵢₙₜₑᵣᵥₐₗ, where fₛₜₐᵣₜ is a frequency location of a lowest candidate SS/PBCH block within the M candidate SS/PBCH blocks, m is an index of a candidate SS/PBCH block within the M candidate SS/PBCH blocks, with 1≤m≤M, and fᵢₙₜₑᵣᵥₐₗ is an interval between two consecutive candidate SS/PBCH blocks within the M candidate SS/PBCH blocks, which is applicable when M>1. In some examples, M, fₛₜₐᵣₜ, and fᵢₙₜₑᵣᵥₐₗ are predefined for a cell in an initial cell search procedure or provided by higher layer parameters for a cell after the initial cell search procedure.

In various embodiments, the UE may determine a candidate SS/PBCH block index ī based on the first index īₜ and the second index ī_{f}, as one of ī=īₜ·M+ī_{f} or ī=ī_{f}·N+īₜ. In various embodiments, the UE determines SS/PBCH blocks are quasi-co-located (QCLed) when the SS/PBCH blocks are with a same value of īₜ and a same value of ī_{f}. For example, in 940, the UE may receive the SS/PBCH block based on the pattern.

The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a processor configured to:
determine a pattern for synchronization signals and physical broadcast channel (SS/PBCH) blocks including N candidate SS/PBCH blocks in a time domain and M candidate SS/PBCH blocks in a frequency domain; and
identify, for a SS/PBCH block, (i) a first index īₜ (0≤īₜ≤N−1) from the N candidate SS/PBCH blocks in the time domain and (ii) a second index ī_{f}(0≤ī_{f}≤M−1) from M candidate SS/PBCH blocks in the frequency domain; and
a transceiver operably coupled to the processor, the transceiver configured to receive, from a base station (BS), the SS/PBCH block based on the pattern.

2. The UE of claim 1, wherein first symbols for the N candidate SS/PBCH blocks in the time domain are given by Sₛₜₐᵣₜ+N_{symb}^{slot}·K·n, where:
K is a number of slots for a predefined time unit;
N_{symb}^{slot} is a number of symbols in a slot;
Sₛₜₐᵣₜ is a set of symbols as first symbols of candidate SS/PBCH blocks within the predefined time unit; and
n is an index of the predefined time unit.

3. The UE of claim 1, wherein frequency locations for the M candidate SS/PBCH blocks in the frequency domain are given by fₛₜₐᵣₜ+(m−1)·fᵢₙₜₑᵣᵥₐₗ, where:
fₛₜₐᵣₜ is a frequency location of a lowest candidate SS/PBCH block within the M candidate SS/PBCH blocks;
m is an index of a candidate SS/PBCH block within the M candidate SS/PBCH blocks, with 1≤m≤M; and
fᵢₙₜₑᵣᵥₐₗ is an interval between two consecutive candidate SS/PBCH blocks within the M candidate SS/PBCH blocks, which is applicable when M>1.

4. The UE of claim 3, wherein M, fₛₜₐᵣₜ, and fᵢₙₜₑᵣᵥₐₗ are:
predefined for a cell in an initial cell search procedure; or
provided by higher layer parameters for a cell after the initial cell search procedure.

5. The UE of claim 1, wherein the processor is further configured to:
determine a candidate SS/PBCH block index ī based on the first index īₜ and the second index ī_{f}, as one of:
$$\overline{ι} = {\overline{ι}}_{t} \cdot M + {\overline{ι}}_{f} ; or$$
$$\overline{ι} = {\overline{ι}}_{f} \cdot N + {\overline{ι}}_{t} .$$

6. The UE of claim 1, wherein the processor is further configured to determine SS/PBCH blocks are quasi-co-located (QCLed) when the SS/PBCH blocks are with a same value of īₜ and a same value of ī_{f}.

7. The UE of claim 1, wherein the processor is further configured to:
determine a first bitmap indicating actually transmitted SS/PBCH blocks in the time domain; and
determine a second bitmap indicating actually transmitted SS/PBCH blocks in the frequency domain.

8. A base station (BS) in a wireless communication system, the BS comprising:
a processor configured to:
determine a pattern for synchronization signals and physical broadcast channel (SS/PBCH) blocks including N candidate SS/PBCH blocks in a time domain and M candidate SS/PBCH blocks in a frequency domain; and
determine, for a SS/PBCH block, (i) a first index īₜ (0≤īₜ≤N−1) from the N candidate SS/PBCH blocks in the time domain and (ii) a second index ī_{f}(0≤ī_{f}≤M−1) from M candidate SS/PBCH blocks in the frequency domain; and
a transceiver operably coupled to the processor, the transceiver configured to transmit, to a user equipment (UE), the SS/PBCH block based on the pattern.

9. The BS of claim 8, wherein first symbols for the N candidate SS/PBCH blocks in the time domain are given by Sₛₜₐᵣₜ+N_{symb}^{slot}·K·n, where:
K is a number of slots for a predefined time unit;
N_{symb}^{slot} is a number of symbols in a slot;
Sₛₜₐᵣₜ is a set of symbols as first symbols of candidate SS/PBCH blocks within the predefined time unit; and
n is an index of the predefined time unit.

10. The BS of claim 8, wherein frequency locations for the M candidate SS/PBCH blocks in the frequency domain are given by fₛₜₐᵣₜ+(m−1)·fᵢₙₜₑᵣᵥₐₗ, where:
fₛₜₐᵣₜ is a frequency location of a lowest candidate SS/PBCH block within the M candidate SS/PBCH blocks;
m is an index of a candidate SS/PBCH block within the M candidate SS/PBCH blocks, with 1≤m≤M; and
fᵢₙₜₑᵣᵥₐₗ is an interval between two consecutive candidate SS/PBCH blocks within the M candidate SS/PBCH blocks, which is applicable when M>1.

11. The BS of claim 10, wherein M, fₛₜₐᵣₜ, and fᵢₙₜₑᵣᵥₐₗ are:
predefined for a cell in an initial cell search procedure; or
provided by higher layer parameters for a cell after the initial cell search procedure.

12. The BS of claim 8, wherein the processor is further configured to:
determine a candidate SS/PBCH block index ī based on the first index īₜ and the second index ī_{f}, as one of:
$$\overline{ι} = {\overline{ι}}_{t} \cdot M + {\overline{ι}}_{f} ; or$$
$$\overline{ι} = {\overline{ι}}_{f} \cdot N + {\overline{ι}}_{t} .$$

13. The BS of claim 8, wherein the processor is further configured to determine SS/PBCH blocks are quasi-co-located (QCLed) when the SS/PBCH blocks are with a same value of īₜ and a same value of ī_{f}.

14. The BS of claim 8, wherein the processor is further configured to:
determine a first bitmap indicating actually transmitted SS/PBCH blocks in the time domain; and
determine a second bitmap indicating actually transmitted SS/PBCH blocks in the frequency domain.

15. A method of a user equipment (UE) in a wireless communication system, the method comprising:
determining a pattern for synchronization signals and physical broadcast channel (SS/PBCH) blocks including N candidate SS/PBCH blocks in a time domain and M candidate SS/PBCH blocks in a frequency domain;
identifying, for a SS/PBCH block, (i) a first index īₜ(0≤īₜ≤N−1) from the N candidate SS/PBCH blocks in the time domain and (ii) a second index ī_{f}(0≤ī_{f}≤M−1) from M candidate SS/PBCH blocks in the frequency domain; and
receiving, from a base station (BS), the SS/PBCH block based on the pattern.

16. The method of claim 15, wherein first symbols for the N candidate SS/PBCH blocks in the time domain are given by Sₛₜₐᵣₜ+N_{symb}^{slot}·K·n, where:
K is a number of slots for a predefined time unit;
N_{symb}^{slot} is a number of symbols in a slot;
Sₛₜₐᵣₜ is a set of symbols as first symbols of candidate SS/PBCH blocks within the predefined time unit; and
n is an index of the predefined time unit.

17. The method of claim 15, wherein frequency locations for the M candidate SS/PBCH blocks in the frequency domain are given by fₛₜₐᵣₜ+(m−1)·fᵢₙₜₑᵣᵥₐₗ, where:
fₛₜₐᵣₜ is a frequency location of a lowest candidate SS/PBCH block within the M candidate SS/PBCH blocks;
m is an index of a candidate SS/PBCH block within the M candidate SS/PBCH blocks, with 1≤m≤M;
fᵢₙₜₑᵣᵥₐₗ is an interval between two consecutive candidate SS/PBCH blocks within the M candidate SS/PBCH blocks, which is applicable when M>1; and
M, fₛₜₐᵣₜ, and fᵢₙₜₑᵣᵥₐₗ are predefined for a cell in an initial cell search procedure, or provided by higher layer parameters for a cell after the initial cell search procedure.

18. The method of claim 15 further comprising:
determining a candidate SS/PBCH block index ī based on the first index īₜ and the second index ī_{f}, as one of:
$$\overline{ι} = {\overline{ι}}_{t} \cdot M + {\overline{ι}}_{f} ; or$$
$$\overline{ι} = {\overline{ι}}_{f} \cdot N + {\overline{ι}}_{t} .$$

19. The method of claim 15 further comprising:
determining SS/PBCH blocks are quasi-co-located (QCLed) when the SS/PBCH blocks are with a same value of īₜ and a same value of ī_{f}.

20. The method of claim 15 further comprising:
determining a first bitmap indicating actually transmitted SS/PBCH blocks in the time domain; and
determining a second bitmap indicating actually transmitted SS/PBCH blocks in the frequency domain.
